(19) United States
(12) Patent Application Publication
(10) Pub. No.: US 2018/0085691 A1
(43) Pub. Date: Mar. 29, 2018

(54) INTEGRAL FILTER CARTRIDGE AND CAP

(71) Applicant: Rolls-Royce Corporation, Indianapolis, IN (US)

(72) Inventors: Thomas Lozier, Lebanon, IN (US); Josh Webb, Romney, IN (US)

(73) Assignee: Rolls-Royce Corporation, Indianapolis, IN (US)

(21) Appl. No.: 15/274,798

(22) Filed: Sep. 23, 2016

(51) Int. Cl. B01D 35/30; B01D 35/14; B01D 35/00

(52) U.S. Cl. CPC B01D 35/30; F02M 37/22; B01D 35/005; B01D 35/14

(57) ABSTRACT

Systems and methods of reducing the likelihood of unfiltered fluid exiting a fluid filtration system. A fluid filtration system comprises a housing, a filtration chamber, a removeable filter cartridge contained within the chamber, and a removable chamber cap forming a boundary of the chamber. A method of assembling the filtration system comprises removably attaching the filter cartridge to the chamber cap and removably attaching the chamber cap to the housing to thereby form the hermetically sealed filtration chamber containing the filter cartridge.

### FIELD OF THE DISCLOSURE

The present disclosure relates generally to filtration, and more specifically to an integral filter cartridge and cap for use in a filtration system.

### BACKGROUND

Filter cartridges are used in a wide range of technologies to filter a fluid. For example, filter cartridges may be used to filter liquid fuel in a fuel filtration system such as can be found in an engine. Fuel filtration systems typically comprise a pump or other means of motive force for the fuel, a fuel tank or reservoir, and a filter assembly comprising a housing, filter cartridge, and cap. Fuel is pumped from the fuel tank, through the filter assembly, and then on to a fuel injection pump, fuel injector, combustor, or other engine component.

Fuel filtration prior to combustion is essential to the continued safe and efficient operation of an engine. The failure to provide a filter cartridge during the initial manufacturing or an engine or the failure to insert a new filter cartridge when an exhausted cartridge is removed during the performance of engine maintenance can each lead to a dangerous condition of operating the engine without a filtration cartridge. Without fuel filtration, components which contact fuel can become clogged or damaged by particulates that have not been properly removed from the fuel. For example, particulates building up in the fuel injectors can cause blockages which result in unexpected and premature engine shutdown.

### SUMMARY

The present application discloses one or more of the features recited in the appended claims and/or the following features which, alone or in any combination, may comprise patentable subject matter.

According to an aspect of the present disclosure, a method of assembling a fluid filtration system is provided. The fluid filtration system comprises a housing, a filtration chamber, a removeable filter cartridge contained within the chamber, and a removable chamber cap forming a boundary of the chamber. The method of assembling the fluid filtration system comprises removably attaching the filter cartridge to the chamber cap; and removably attaching the chamber cap to the housing to thereby form the hermetically sealed filtration chamber containing the filter cartridge.

In some embodiments removably attaching the chamber cap to the housing comprises threadably engaging a threaded annulus of the chamber cap to the housing. In some embodiments removably attaching the filter cartridge to the chamber cap comprises attaching the filter cartridge to the chamber cap by a means requiring a removing tool to remove the filter cartridge from the chamber cap. In some embodiments the removing tool is one or more of a wrench, a ratchet, or a tool configured to depress the retention mechanism.

In some embodiments attaching the filter cartridge to the chamber cap comprises permanently coupling the filter cartridge and the chamber cap via a retention mechanism such that replacement of the filter cartridge requires replacement of the chamber cap. In some embodiments said filter cartridge comprises a hollow cylinder defining an inner filter volume and said filter cartridge is composed of at least one filter media. In some embodiments said housing comprises a fluid inlet fluidly coupled to said inner filter volume and a fluid outlet coupled to a portion of said filtration chamber around said filter cartridge. In some embodiments said housing comprises a fluid inlet fluidly coupled to a portion of said filtration chamber around said filter cartridge and a fluid outlet coupled to said inner filter volume.

According to another aspect of the present disclosure, a fluid filter assembly comprises an assembly housing having a fluid inlet and a fluid outlet, the assembly housing partially defining a filtration chamber; an assembly cap having a surface configured to seal against the assembly housing and a threaded annulus configured to threadably couple the assembly cap to the assembly housing; and a filter cartridge coupled to the assembly cap by a filter retention mechanism.

In some embodiments the retention mechanism is one or more of an annular spring-loaded retainer, a fastener, and an adhesive. In some embodiments the filter cartridge and the assembly cap are permanently coupled such that replacement of the filter cartridge requires replacement of the chamber cap. In some embodiments said assembly cap further comprises a gripping portion. In some embodiments said filter cartridge comprises a hollow cylinder defining an inner filter volume and said filter cartridge is composed of at least one filter media. In some embodiments said fluid inlet is fluidly coupled to said inner filter volume and said fluid outlet is coupled to a portion of said filtration chamber around said filter cartridge. In some embodiments said fluid inlet is fluidly coupled to a portion of said filtration chamber around said filter cartridge and said fluid outlet is coupled to said inner filter volume.

According to yet another aspect of the present disclosure, a method of assembling a fluid filtration system comprises obtaining a fluid filter cartridge from a supplier; obtaining a filter cap from a supplier; inserting the fluid filter cartridge into the fluid filtration system; and installing the filter cap to thereby hermetically seal the fluid filtration system containing an inserted fluid filter cartridge, wherein the fluid filter cartridge and the filter cap are obtained as a coupled unit from the supplier.

In some embodiments the fluid filter cartridge is coupled to the filter cap by a means selected from the group consisting of a spring-load retainer, a snap-fit retainer, fasteners, adhesive, welding, or brazing. In some embodiments installing the filter cap comprises threadably engaging a threaded annulus of the filter cap to the housing. In some embodiments attaching the filter cartridge to the filter cap comprises permanently coupling the filter cartridge and the filter cap via a retention mechanism such that replacement of the filter cartridge requires replacement of the filter cap. In some embodiments said filter cartridge comprises a hollow cylinder defining an inner filter volume and said filter cartridge is composed of at least one filter media.

### BRIEF DESCRIPTION OF THE DRAWINGS

The following will be apparent from elements of the figures, which are provided for illustrative purposes and are not necessarily to scale.

FIG. 1 is a side cutaway view of a filter assembly of a fluid filtration system in accordance with some embodiments of the present disclosure.

FIG. 2 is a side cutaway view of a filter assembly of a fluid filtration system in accordance with some embodiments of the present disclosure.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

For the purposes of promoting an understanding of the principles of the disclosure, reference will now be made to a number of illustrative embodiments illustrated in the drawings and specific language will be used to describe the same.

This disclosure presents systems and methods of providing fluid filtration. More specifically, the present disclosure is directed to an integral fluid filter cartridge and cap, which reduce the likelihood that a cap will be installed on a filter assembly without a filter cartridge. This reduces the likelihood that a fluid filtration system will be operated without a fluid filter cartridge installed in the filter assembly.

Operation of a fluid filtration system without an installed fluid filter cartridge can result in damage and destruction of equipment connected to the fluid filtration system. For example, a fuel or lubrication filtration system connected to a turbine engine, if operated without a filter cartridge, can send unfiltered fuel or lubricant to the engine which can cause damage, performance degradation, and even destruction of the engine.

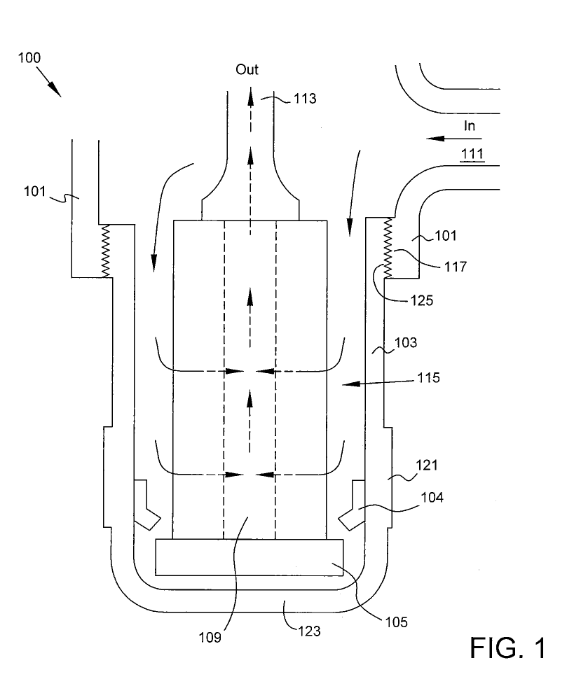

FIG. 1 presents a side cutaway view of a filter assembly 100 which comprises a housing 101, a removeable chamber cap 103 at least partially defining a filtration chamber 115, and a removeable filter cartridge 105 disposed in the filtration chamber 115. Filter assembly 100 is part of a filtration system comprising a pump or other means of motive force for fluid being filtered and a fluid tank or reservoir. Fluid is pumped from the tank, through the filter assembly 100, and then on to a component requiring filtered fluid. As a non-limiting example, liquid fuel can be pumped from a fuel tank, filtered through the illustrated filter assembly 100, and sent to a fuel injection pump, fuel injector, combustor, or other engine component which handles filtered fuel.

Housing 101 includes an inlet 111 and outlet 113. Housing 101 further includes a threaded portion 117 adapted to couple housing 101 to cap 103. In some embodiments threaded portion 117 comprises female threads.

Cap 103 is a hollow cylindrical body having a closed end 123. Cap 103 includes a grip portion 121 and threaded annulus 125. The threaded annulus 125 is adapted to removeably couple cap 103 to housing 101. In some embodiments threaded annulus 125 comprises male threads. Cap 103 and housing 101 form the fluid boundary of the filter assembly 100.

Filter cartridge 105 may be a single- or dual-media filter which is sized to substantially occupy a filtration chamber 115 which is at least partially bound by cap 103. In some embodiments, filter cartridge 105 may be a hollow cylinder which defines an inner filter volume 109.

With filter cartridge 105 and cap 103 coupled to housing 101, fluid may pass from inlet 111 to outlet 113 only by passing through the filter cartridge 105, thus requiring the fluid to pass through a filter media which removed impurities and particulates of a predetermined size or composition.

As illustrated with arrows showing the fluid flowpaths in FIG. 1, in some embodiments fluid entering through the inlet 111 of housing 101 flows down into the filtration chamber 115, passes over and through at least one filtration layer of the filter cartridge 105, and passes through the center of the hollow cylinder and into the outlet 113. In some embodiments filter assembly 100 may be configured such that inlet 111 directs fluid into the center of the filter cartridge 105, and fluid then passes through the filter cartridge 105 and along the outside of the filter cartridge 105 to an outlet 113.

To reduce the likelihood that filter assembly 100 is not operated without a filter cartridge 105 installed, cap 103 further includes a retention mechanism 104. Without a retention mechanism 104, it is possible to remove the cap 103, remove the filter cartridge 105, and re-secure the cap 103 without re-installing or replacing the filter cartridge 105. Similarly, it is possible to install cap 103 during manufacture of the filter assembly 100 without installing a filter cartridge 105 prior to initial use of the filter assembly 100. In such instances, the filtration system of the filter assembly 100 may be operated without an installed filter cartridge 105, which removes the ability of the filtration system to filter fluids. Such operation can and does result in the introduction of non-filtered fluids into undesirable locations.

For this reason, it is desirable to provide an integral cap 103 and filter cartridge 105 assembly such that replacement of the filter cartridge 105 necessarily requires replacement of cap 103. In some embodiments, the retention mechanism 104 may be configured to permanently couple the filter cartridge 105 to the cap 103. The retention mechanism 104 may be annular or may have discrete components spaced around the inner circumference of the cap 103. In some embodiments, the retention mechanism 104 may be spring loaded and/or snap fit. In the illustrated embodiment, the filter cartridge 105 is inserted into the cap 103 until the retention mechanism 104 is engaged, which prevents the filter cartridge 105 from being removed from cap 103.

Additional retention mechanisms 104 are contemplated. For example, the filter cartridge 105 and cap 103 can be integrally coupled using an adhesive, welding, or brazing. In other embodiments, filter cartridge 105 and cap 103 can be integrally coupled using hardware such as fasteners.

In some embodiments, a removing tool (not shown) is required to engage the retention mechanism 104 in order to release the filter cartridge 105. In some embodiments, the removing tool may be one of a wrench, a ratchet, a special designed tool used to depress the retention mechanism 104, or a similar tool.

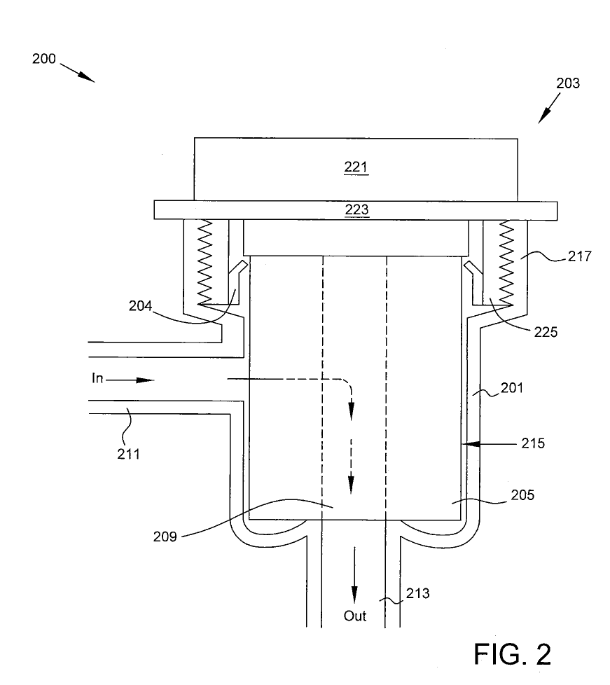

FIG. 2 presents a filter assembly 200 comprising housing 201, cap 203, and filter cartridge 205. In the embodiment illustrated in FIG. 2, housing 201 partially defines a filtration chamber 215 which is substantially filled by filter cartridge 205. In some embodiments housing 201 may be substantially cylindrical.

The filtration chamber 215 is further defined by a cap 203. Cap 203 comprises a grip portion 221, sealing member 223, and threaded annulus 225. Threaded annulus 225 is configured to be threadably coupled to a threaded portion 217 of housing 201. In some embodiments threaded annulus 225 comprises male threads and threaded portion 217 comprises female threads.

As with the embodiment of FIG. 1, the filter cartridge 205 and cap 203 are integrally coupled using a retention mechanism 204. In some embodiments, the filter cartridge 105 may be permanently coupled to an improved cap 203. Filter cartridge 205 may be a hollow cylinder which defines an inner filter volume 209.

In some embodiments, filter cartridges 105, 205 and caps 103, 203 are coupled during manufacturing, such that the integral filter cartridges 105, 205 and caps 103, 203 combination is transported to a maintenance site as a single unit. Thus, a maintenance performer would remove and dispose of an exhausted filter cartridges 105, 205 and caps 103, 203 combination, and replace it with a new filter cartridges 105, 205 and caps 103, 203 combination which was already coupled.

In some embodiments, filter cartridges 105, 205 and caps 103, 203 are permanently coupled during performance of maintenance on the filter assembly 100, 200. Thus, a maintenance performer would first obtain new filter cartridges 105, 205 and caps 103, 203, then couple the filter cartridges 105, 205 and caps 103, 203. The performer would remove and dispose of an exhausted filter cartridges 105, 205 and caps 103, 203 combination, and replace it with the new filter cartridges 105, 205 and caps 103, 203 combination which was already coupled.

As an alternative, relative to the embodiment of FIG. 2 the filter cartridge 205 and cap 203 may be permanently coupled during performance of maintenance on the filter assembly 200 by first inserting the filter cartridge 205 into the filtration chamber 215 and then threading the cap 203 onto the housing 201. In such an embodiment, as the cap is threaded down onto the housing 201, the retention mechanism 204 is engaged, rendering the filter cartridge 205 and cap 203 permanently coupled. In this embodiment, although the filter cartridge 205 and cap 203 are transported and installed separately into the filter assembly 200, the permanent coupling of the filter cartridge 205 and cap 203 is advantageous as it requires the replacement of both the filter cartridge 205 and cap 203 once exhausted. This decreases the likelihood of operating the filter assembly 200 without the filter cartridge 205 installed because the filter cartridge 205 cannot be removed from the cap 203, and thus cap 203 cannot be re-coupled to the housing 201 without a filter cartridge attached.

In some embodiments the retention mechanism 104, 204 retains the filter cartridge 105, 205 in cap 103, 203 until a release mechanism (not shown) such as a tool or pushbutton is engaged and the retention mechanism releases the filter cartridge 105, 205 from the cap 103, 203. The use of a release mechanism allows the cap 103, 203 to be re-used, while the exhausted filter cartridge 105, 205 is discarded or refurbished for future use.

The present disclosure further provides a method of assembling a filtration system. The filtration system comprises a housing 101, a removable chamber cap 103 partly defining a filtration chamber 115, and a removable filter cartridge 105. The disclosed method comprises removably attaching the filter cartridge 105 to the cap 103, and removably attaching the cap 103 to the housing 101 to thereby form a hermetically sealed filtration chamber 115 containing the filter cartridge 105. In some embodiments removably attaching the cap 103 to the housing 101 comprises threadably engaging the threaded annulus 125 of the cap 103 to the housing 101. In some embodiments removably attaching the filter cartridge 105 to the cap 103 comprises engaging a retention mechanism 104, and in some embodiments the retention mechanism 104 requires a removing tool to remove the filter cartridge 105 from the cap 103.

The present disclosure is advantageous over existing filtration systems and filter assemblies in that it reduces the possibility that the filtration system will be operated without a filter cartridge installed. This advantage results in a decreased likelihood that unfiltered fluids will be passed from the filtration system, which in turn reduces the likelihood of damage to associated or connected equipment. In the example of a fuel filtration system coupled to an engine, the present disclosure discusses systems and methods which reduce the likelihood that unfiltered fuel will be passed to the fuel injectors, fuel injection pump, fuel injector, combustor, or other engine component. It is known in the art that unfiltered fuel passing through these engine components can cause damage and degrade the performance of the engine.

Although examples are illustrated and described herein, embodiments are nevertheless not limited to the details shown, since various modifications and structural changes may be made therein by those of ordinary skill within the scope and range of equivalents of the claims.

What is claimed is:

1. In a fluid filtration system comprising a housing, a filtration chamber, a removeable filter cartridge contained within the chamber, and a removable chamber cap forming a boundary of the chamber, a method of assembling the filtration system comprising:
removably attaching the filter cartridge to the chamber cap; and
removably attaching the chamber cap to the housing to thereby form the hermetically sealed filtration chamber containing the filter cartridge.

2. The method of claim 1 wherein removably attaching the chamber cap to the housing comprises threadably engaging a threaded annulus of the chamber cap to the housing.

3. The method of claim 1 wherein removably attaching the filter cartridge to the chamber cap comprises attaching the filter cartridge to the chamber cap by a means requiring a removing tool to remove the filter cartridge from the chamber cap.

4. The method of claim 3 wherein the removing tool is one or more of a wrench, a ratchet, or a tool configured to depress the retention mechanism.

5. The method of claim 1 wherein attaching the filter cartridge to the chamber cap comprises permanently coupling the filter cartridge and the chamber cap via a retention mechanism such that replacement of the filter cartridge requires replacement of the chamber cap.

6. The method of claim 1 wherein said filter cartridge comprises a hollow cylinder defining an inner filter volume and said filter cartridge is composed of at least one filter media.

7. The assembly of claim 6, wherein said housing comprises a fluid inlet fluidly coupled to said inner filter volume and a fluid outlet coupled to a portion of said filtration chamber around said filter cartridge.

8. The assembly of claim 6, wherein said housing comprises a fluid inlet fluidly coupled to a portion of said filtration chamber around said filter cartridge and a fluid outlet coupled to said inner filter volume.

9. A fluid filter assembly comprising:
an assembly housing having a fluid inlet and a fluid outlet, the assembly housing partially defining a filtration chamber;
an assembly cap having a surface configured to seal against the assembly housing and a threaded annulus configured to threadably couple the assembly cap to the assembly housing; and
a filter cartridge coupled to the assembly cap by a filter retention mechanism.

10. The assembly of claim 9 wherein the retention mechanism is one or more of an annular spring-loaded retainer, a fastener, and an adhesive.

11. The assembly of claim 10 wherein the filter cartridge and the assembly cap are permanently coupled such that replacement of the filter cartridge requires replacement of the chamber cap.

12. The assembly of claim 9 wherein said assembly cap further comprises a gripping portion.

13. The assembly of claim 9 wherein said filter cartridge comprises a hollow cylinder defining an inner filter volume and said filter cartridge is composed of at least one filter media.

14. The assembly of claim 13, wherein said fluid inlet is fluidly coupled to said inner filter volume and said fluid outlet is coupled to a portion of said filtration chamber around said filter cartridge.

15. The assembly of claim 13, wherein said fluid inlet is fluidly coupled to a portion of said filtration chamber around said filter cartridge and said fluid outlet is coupled to said inner filter volume.

16. A method of assembling a fluid filtration system comprising:
obtaining a fluid filter cartridge from a supplier;
obtaining a filter cap from a supplier;
inserting the fluid filter cartridge into the fluid filtration system; and
installing the filter cap to thereby hermetically seal the fluid filtration system containing an inserted fluid filter cartridge, wherein the fluid filter cartridge and the filter cap are obtained as a coupled unit from the supplier.

17. The method of claim 16 wherein the fluid filter cartridge is coupled to the filter cap by a means selected from the group consisting of a spring-load retainer, a snap-fit retainer, fasteners, adhesive, welding, or brazing.

18. The method of claim 16 wherein installing the filter cap comprises threadably engaging a threaded annulus of the filter cap to the housing.

19. The method of claim 16 wherein attaching the filter cartridge to the filter cap comprises permanently coupling the filter cartridge and the filter cap via a retention mechanism such that replacement of the filter cartridge requires replacement of the filter cap.

20. The method of claim 16 wherein said filter cartridge comprises a hollow cylinder defining an inner filter volume and said filter cartridge is composed of at least one filter media.
